(19) United States
(12) Patent Application Publication
(10) Pub. No.: US 2005/0017109 A1
(43) Pub. Date: Jan. 27, 2005

(54) Grinding tool

(76) Inventor: Hsieh-Min Tu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/616,930

(22) Filed: Jul. 11, 2003

(51) Int. Cl. B02C 1/08

(52) U.S. Cl. 241/242

(57) ABSTRACT

A grinding tool includes a toothed grinding wheel, two opposing stationary grinding members, and an actuating wheel; the grinding wheel is connected to a transmission shaft turnably connected to a housing and having an engaging end projecting from the housing; the stationary grinding members are fixedly disposed in the housing, and have grinding teeth on inward surfaces facing the grinding wheel; the actuating wheel is connected to the engaging end of the shaft at a middle connecting hole so that rotation of the actuating wheel can be passed on to the grinding wheel by means of the shaft; thus, contents of the housing can be ground with the grinding wheel and the stationary grinding members by means of holding the housing still, and turning the actuating wheel to and fro repeatedly.

### BACKGROUND OF THE INVENTION

1. Field of the Invention

The present invention relates to a grinding tool, more particularly one, which is easy and takes less strength to use, and which is structured such that an increased proportion of the room within a housing member thereof can be provided for containing foods to be ground with the tool.

2. Brief Description of the Prior Art

Referring to FIG. 5, a popular conventional grinding tool includes a main housing body 10, a rotary cap 80 covering an upper opening of the housing body 10 and rotary on the body 10, a fixing base 60 secured to a lower opening of the housing body 10 and having a lower opening, a toothed outer grinding member 50 secured to an inner annular side of the fixing base 60, a shaft 20 turnably disposed along the central axis of the housing body 10 and passed through the top of the cap 80, an uppermost connector 801 secured to the upper end of the shaft 20, a toothed inner grinding member 30 arranged in the outer grinding member 50 and joined to a lower end of the shaft 20, an elastic element 40 biasing the inner grinding member 30 downwards, and a nut 70 screwed to the lower end of the shaft 20. Thus, contents of the housing body 10 can be ground by means of the toothed inner and the toothed outer grinding members 30 and 50 when the rotary cap 80 is turned relative to the housing body 10 to cause the inner member 30 to turn relative to the outer member 50.

The grinding tool is found to have disadvantages as followings:
1. When using the tool to grinding the contents, the user has to hold the main housing body 10 with one hand, and the rotary cap 80 with the other hand, and has to make the main housing body 10 and the rotary cap 80 turn in opposite directions at the same time. Consequently, both hands will become hindrance to each other frequently in the course of operating the grinding tool, and in turns, the user has to change orientation of one hand relative to the tool frequently. Therefore, the grinding tool is not convenient to use.
2. Because the shaft 20 is relatively long in length, which is used for passing on rotation of the rotary cap 80 to the inner grinding member 30, it will take the user more labor to turn the cap 80 to make the inner grinding member 30 turn in operating the grinding tool.
3. Certain proportion of the room within the main housing body 10 is occupied due to the shaft 20. Consequently, the proportion of the room is reduced that can be provided for containing objects to be ground.

### SUMMARY OF THE INVENTION

It is a main object of the present invention to provide a grinding tool so as to overcome the above disadvantages.

The grinding tool includes a toothed grinding wheel, two opposing stationary grinding members, and an actuating wheel. The grinding wheel is arranged in a lower portion of a housing, and connected to a transmission shaft. The shaft has an engaging end projecting from the housing. The stationary grinding members are fixedly arranged in front and rear sections of the lower portion of the housing. The stationary grinding members have grinding teeth on inward surfaces facing the grinding wheel. The actuating wheel is connected to the engaging end of the shaft so that rotation of the actuating wheel can be passed on to the grinding wheel by means of the shaft. Thus, contents of the housing can be ground by means of the grinding wheel and the stationary grinding members when the housing is held still, and the actuating wheel is turned to and fro repeatedly.

### BRIEF DESCRIPTION OF THE DRAWINGS

The present invention will be better understood by referring to the accompanying drawings, wherein:

FIG. 1 is an exploded perspective view of the grinding tool according to the present invention,

FIG. 2 is a front view of the grinding tool of the present invention,

FIG. 3 is a side view of the grinding tool of the present invention,

FIG. 4 is a view showing the grinding tool of the present invention being used, and

FIG. 5 is a cross-sectional view of the conventional grinding tool as described in the Background.

### DETAILED DESCRIPTION OF THE PREFERRED EMBODIMENTS

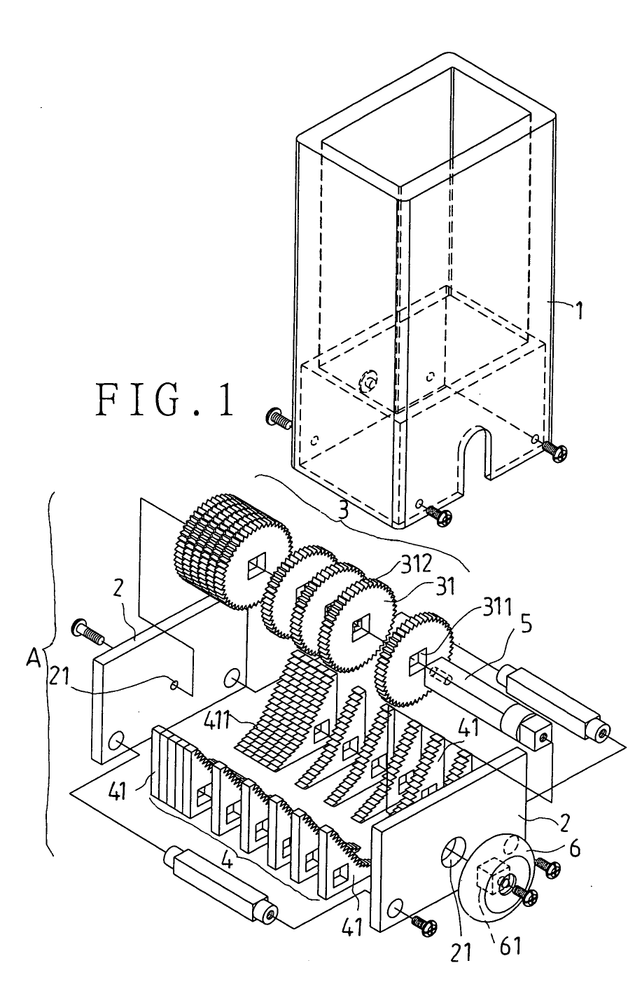

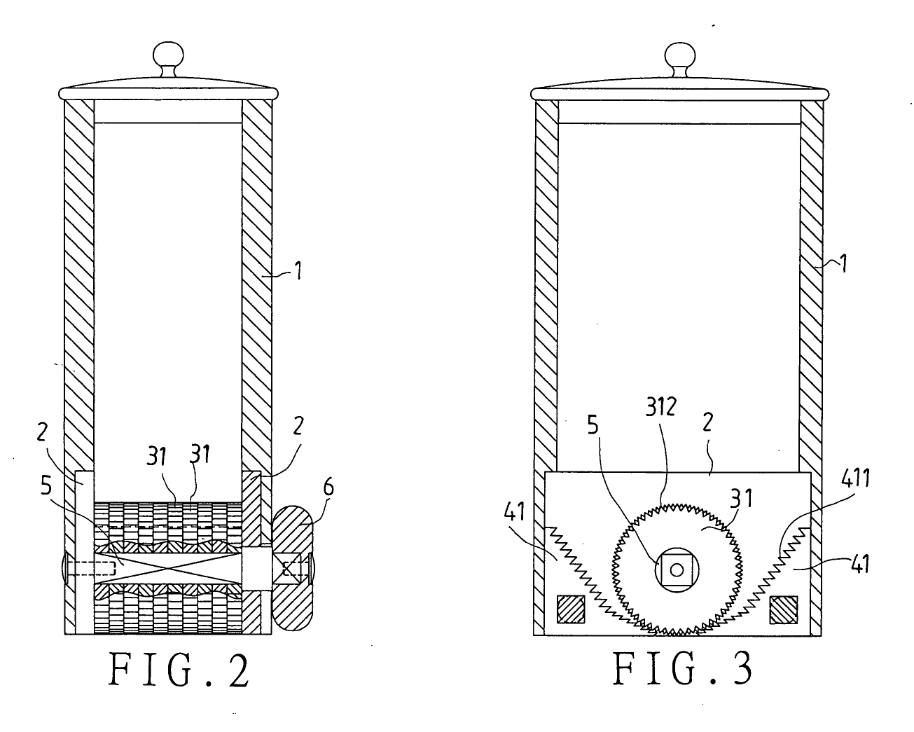

Referring to FIGS. 1 to 3, a preferred embodiment of a grinding tool in the present invention includes a housing 1, and a grinding mechanism (A).

The housing 1 has an opening (not numbered) at a lower end while the grinding mechanism includes:
two lateral fixing walls 2, 2; the fixing walls 2, 2 are fixedly secured to inner sides of lateral portions of the housing 1; the fixing walls 2, 2 have opposing pivotal holes 21, 21;
a grinding wheel 3 rotary in the housing 1; the grinding wheel 3 is comprised of several circular flat grinding plates 31, each of which is formed with grinding teeth 312 on the edge; the circular flat grinding plates 31 are disposed one next to another, and positioned in such a manner that the grinding teeth 312 of one grinding plate 31 overlap the grinding teeth 312 of the adjacent grinding plates 31; the circular flat grinding plates 31 are securely joined together; each grinding plate 31 has a connecting hole 311 at the middle;
two stationary grinding members 4, 4 respectively fixedly disposed in front and rear portions of inside of the housing 1 for allowing contents of the housing to be ground between the wheel 3 and the stationary members 4; each stationary grinding member 4 is comprised of several flat grinding plates 41 arranged one next to another between the fixing walls 2; the plates 41 are secured to the inner sides of the front and rear portions of the housing 1; each of the flat grinding plates 41 has several grinding teeth 411 at a first edge thereof; the grinding plates 41 are formed in such a manner that each grinding tooth 411 thereof is bigger than those teeth 411 that are lower than it in position; each grinding plate 41 is formed in such a manner that the sharp ends of the teeth 411 thereof together define a shape substantially similar to a folded line, which consists of a lower section, and an upper section steeper than the lower section;
a transmission shaft 5 having a first engaging end portion (not numbered), and a cylindrical section (not numbered) near to the first engaging end portion thereof; the transmission shaft 5 is turnably connected to the pivotal holes 21, 21 of the fixing walls 2, 2; the shaft 5 is fitted in the connecting holes 311 of the circular flat grinding plates 31 so that the grinding plates 311 can turn together with the shaft 5; the first engaging end portion of the shaft 5 projects out from the corresponding wall 2 and the housing 1; and
an actuating wheel 6; the actuating wheel 6 has a connecting hole 61 at the middle, and is connected to the shaft 5 with the first engaging end portion of the shaft 5 being fitted in the connecting hole 61 so that rotation of the actuating wheel 6 can be passed on to the grinding wheel 3 by means of the shaft 5.

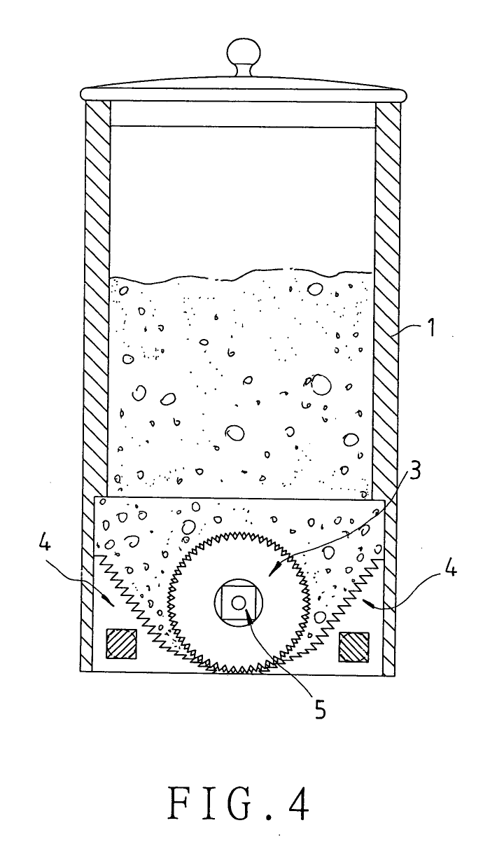

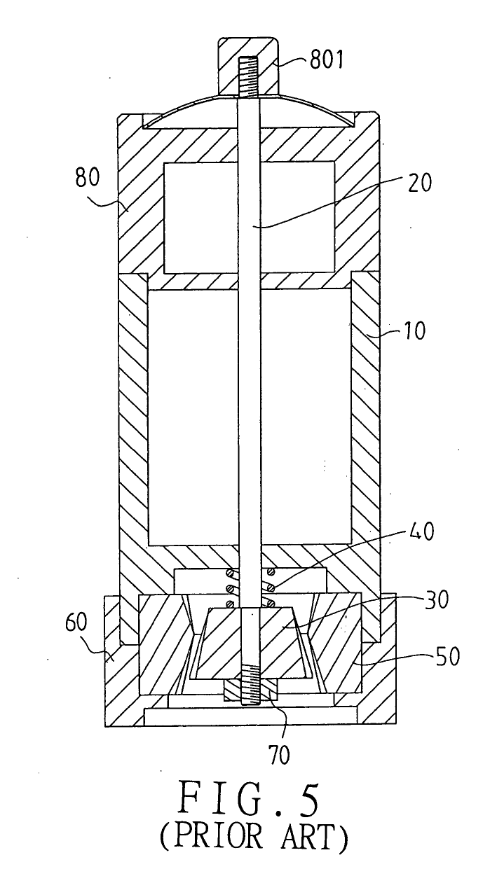

To use the present grinding tool to grind the contents, referring to FIG. 4, first, the user holds the housing 1 still with one hand, and turns the actuating wheel 6 to and fro repeatedly with the other hand. Thus, the grinding wheel 3 is turned in the same way to cooperate with the teeth 411 of the stationary grinding members 4, 4 to break the contents into small pieces, which then pass down via the lower opening of the housing 1.

From the above description, it can be easily understood that the grinding tool of the present invention has advantages as followings:
1. Because grinding teeth 312 of each circular grinding plate 31 overlap grinding teeth 312 of adjacent circular grinding plates 31, the grinding tool can grind the contents more efficiently, and the contents of the tool won't be deposited in the space between the teeth 312 after they have been ground into small pieces.
2. Because the teeth 411 of the grinding plates 41 decrease in size gradually from an uppermost one to a lowermost one, and because sharp ends of the teeth 411 of each grinding plate 41 together define a shape substantially similar to a folded line consisting of a lower section, and an upper section steeper than the lower section, the contents of the grinding tool can be easily and effectively crushed and ground by means of the teeth 411 and 312.
3. The user only has to hold the housing 1 still with one hand, and turn the actuating wheel 6 to and fro repeatedly with the other hand to grind the contents of the grinding tool therefore both of the user's hands won't become hindrance to each other in the course of operating the grinding tool, i.e. the tool is easier to operated than the prior one as described in the Background.
4. In the present grinding tool, there is no other parts disposed above the grinding mechanism, not like the prior tool. Consequently, all of the room above the grinding mechanism in the housing 1 can be used for containing contents to be ground. In other words, larger amount of contents can be held in the preset tool in case both the present and the prior tools are provided with space of the same size above the grinding mechanisms.

1. An improvement on a grinding tool, comprising
a housing having an opening at a lower end;
two opposing fixing walls fixedly secured to inner sides of lateral portions of the housing; the fixing walls having opposing pivotal holes;
a grinding wheel; the grinding wheel including a plurality of circular flat grinding plates each formed with grinding teeth on an edge; the circular flat grinding plates being disposed one next to another, and securely joined together; the circular flat grinding plates being positioned in such a manner that each grinding plate overlap grinding teeth of adjacent grinding plates at grinding teeth thereof; each grinding plate having a middle connecting hole; the grinding wheel being rotary in the housing together with a transmission shaft, which is fitted into the middle connecting holes, and turnably passed through the pivotal holes of the fixing walls;
the transmission shaft having a first engaging end portion projecting out of the housing;
two opposing stationary grinding members fixedly disposed in the housing; the stationary grinding members each including a plurality of flat grinding plates arranged one next to another between the fixing walls; each of the flat grinding plates having a plurality of grinding teeth at a first edge facing the grinding wheel; and
an actuating wheel; the actuating wheel being connected to the first engaging end portion of the transmission shaft at a middle connecting hole thereof so that rotation of the actuating wheel can be passed on to the grinding wheel by means of the shaft;
contents of the housing being capable of being ground with the grinding teeth of the grinding wheel and the stationary grinding members by means of holding the housing still, and turning the actuating wheel to and fro repeatedly.

2. The grinding tool as claimed in claim 1, wherein the grinding teeth of each grinding plate of the stationary grinding members decrease in size gradually from an uppermost one to a lowermost one.

3. The grinding tool as claimed in claim 1, wherein each grinding plate of the stationary grinding members is formed in such a manner that sharp ends of the grinding teeth thereof together define a shape substantially similar to a folded line consisting of a lower section, and an upper section steeper than the lower section.
